(19) United States
(12) Patent Application Publication
(10) Pub. No.: US 2016/0132147 A1
(43) Pub. Date: May 12, 2016

(54) CAPACITIVE TOUCH SYSTEM AND FREQUENCY SELECTION METHOD THEREOF

(71) Applicant: PIXART IMAGING (PENANG) SDN.BHD., Penang (MY)

(72) Inventor: WOOI-KIP LIM, PENANG (MY)

(21) Appl. No.: 14/538,964

(22) Filed: Nov. 12, 2014

(51) Int. Cl. G06F 3/044

(52) U.S. Cl. CPC G06F 3/044

(57) ABSTRACT

There is provided a capacitive touch system including a touch panel, a plurality of amplification units, a plurality of anti-aliasing filters and a control unit. The touch panel includes a plurality of driving electrodes and a plurality of sensing electrodes configured to form inductive capacitance. The amplification units have a high-pass cutoff frequency. The anti-aliasing filters have a low-pass cutoff frequency. The control unit is configured to control the high-pass cutoff frequency and the low-pass cutoff frequency to form an equivalent bandpass filter in a frequency scanning interval and adjust a center frequency of the equivalent bandpass filter to correspond to a plurality of predetermined driving frequencies.

### BACKGROUND

1. Field of the Disclosure

This disclosure generally relates to an interactive input device and, more particularly, to a capacitive touch system and a frequency selection method thereof.

2. Description of the Related Art

As the capacitive touch panel can provide a better user experience, it has been broadly applied to various electronic devices, e.g. applying to a display device so as to form a touch display device.

For example FIG. 1 is a schematic block diagram of the conventional capacitive touch system which includes a capacitive touch panel 91, a plurality of signal generators 92, a plurality of driving units 93, an analog front end 94, a digital back end 95 and a processing unit 96. The capacitive touch panel 91 includes a plurality of driving electrodes 911 intersecting with a plurality of sensing electrodes 912, wherein a mutual capacitance is formed between one of the driving electrodes 911 and one of the sensing electrodes 912. Each of the signal generators 92 and driving units 93 are coupled to one of the driving electrodes 911 for inputting a driving signal Sd. The sensing electrodes 912 output a sensing signal Ss, which is induced from the driving signal Sd through the mutual capacitance between the driving electrodes 911 and the sensing electrodes 912, to the analog front end 94. The analog front end 94 converts the sensing signal Ss to the digital signal which is then sent to the digital back end 95 for post-processing. The digital back end 95 is coupled to the processing unit 96 which identifies a touch position according to the post-processed result of the digital back end 95.

As values of the touch signals outputted from the capacitive touch panel 91 are very small and when the capacitive touch panel 91 is applied to a liquid crystal display, the touch signals can be interfered by gate driving signals of the liquid crystal display easily thereby reducing the signal-to-noise ratio (SNR) of the touch signals.

Generally, if the noise of the touch signals obtained at a current driving frequency is too high, another driving frequency can be selected by so-called frequency hopping process in which the driving frequency having a better SNR value is detected and the selected driving frequency will be used in the touch detection. However, in the conventional frequency selection process the driving signal is still inputted to each driving electrode and touch signals are detected for a plurality of frames such that a long frequency selection interval and the power consumption are unavoidable.

For example, taking a driving frequency of 200 KHZ and scanning two frames as an example, in a condition of having 20 driving electrodes and each of the driving electrodes being inputted by 20 cycles of driving waveforms, 6.4 ms=(32 cycles×20 channels/200 KHZ)×2 frames is necessary in order to detect a single driving frequency and this interval could make the user feel the operation interruption. If a plurality of driving frequencies have to be detected continuously, more time and power consuming are necessary.

### SUMMARY

Accordingly, the present disclosure provides a capacitive touch system and a frequency selection method thereof capable of reducing a frequency scanning interval and the power consumption in the frequency scanning interval.

The present disclosure provides a capacitive touch system and a frequency selection method thereof in which a suitable driving frequency is selected without inputting driving waveforms in a frequency scanning interval thereby reducing the power consumption in the frequency scanning interval.

The present disclosure provides a capacitive touch system including a touch panel, a driving unit, a plurality of amplification units, a plurality of filters and a scan control unit. The touch panel includes a plurality of driving electrodes and a plurality of sensing electrodes configured to form inductive capacitance. The driving unit is coupled to one of the driving electrodes and configured to output a driving signal at one of a plurality of predetermined driving frequencies in a driving interval and not output the driving signal to the driving electrode coupled thereto in a frequency scanning interval. The amplification units are respectively coupled to the sensing electrodes and configured to amplify a detecting signal outputted by the sensing electrode coupled thereto, and have a high-pass cutoff frequency. The filters are respectively coupled to the amplification units and configured to output an amplified and filtered detecting signal, and have a low-pass cutoff frequency. The scan control unit is configured to control the high-pass cutoff frequency and the low-pass cutoff frequency in the frequency scanning interval to form an equivalent bandpass filter and adjust a center frequency of the equivalent bandpass filter to correspond to the predetermined driving frequencies.

The present disclosure further provides a frequency selection method of a capacitive touch system, wherein the capacitive touch system includes a touch panel, a plurality of amplification units respectively coupled to a plurality of sensing electrodes of the touch panel, and a plurality of filters respectively coupled to the amplification units. The frequency selection method includes the steps of: driving the touch panel with a driving signal at a current driving frequency to allow the filters to respectively output an amplified and filtered detecting signal; entering a frequency scanning interval when an SNR value of the amplified and filtered detecting signal is smaller than a threshold; stopping driving the touch panel in the frequency scanning interval; controlling a high-pass cutoff filter of the amplification filters and a low-pass cutoff frequency of the filters to form an equivalent bandpass filter; and adjusting a center frequency of the equivalent bandpass filter to correspond to a plurality of predetermined driving frequencies.

The present disclosure further provides a frequency selection method of a capacitive touch system, wherein the capacitive touch system includes a driving unit, a touch panel, a plurality of amplification units respectively coupled to a plurality of sensing electrodes of the touch panel, and a plurality of filters respectively coupled to the amplification units. The frequency selection method has a frequency scanning interval, in which the driving unit does not output any driving signal to the touch panel, the amplification units and the filters are configured to form an equivalent bandpass filter to output an amplified and filtered background signal, and a selected driving frequency is determined according to the amplified and filtered background signal obtained by adjusting a center frequency of the equivalent bandpass filter.

The present disclosure further provides readout circuit configured to couple to a touch panel and read a plurality of detecting signals outputted by the touch panel. The readout circuit includes a plurality of amplification units, a plurality of filters and a scan control unit. The amplification units are coupled to the touch panel and configured to amplify the detecting signals outputted by the touch panel, and have a high-pass cutoff frequency. The filters are respectively coupled to the amplification units and configured to output an amplified and filtered detecting signal, and have a low-pass cutoff frequency. The scan control unit is configured to control the high-pass cutoff frequency and the low-pass cutoff frequency to form an equivalent bandpass filter, and adjust a center frequency of the equivalent bandpass filter to correspond to at least a part of a plurality of predetermined driving frequencies of the touch panel.

In the capacitive touch system and the frequency selection method according to some embodiments of the present disclosure, the amplification units are configured as high-pass filters and have a high-pass cutoff frequency, and the filters are configured as low-pass filters and have a low-pass cutoff frequency. The control unit is configured to control the high-pass cutoff frequency and the low-pass cutoff frequency in a frequency scanning interval to form an equivalent bandpass filter, adjust a center frequency of the equivalent bandpass filter to correspond to a plurality of predetermined driving frequencies, and select an amplified and filtered background signal having a smallest energy value among the amplified and filtered background signals associated with the predetermined driving frequencies to accordingly determine a selected driving frequency.

### BRIEF DESCRIPTION OF THE DRAWINGS

Other objects, advantages, and novel features of the present disclosure will become more apparent from the following detailed description when taken in conjunction with the accompanying drawings.

FIG. 1 is a schematic block diagram of the conventional capacitive touch system.

FIG. 2 is a schematic block diagram of a capacitive touch system according to one embodiment of the present disclosure.

FIG. 3 is a schematic block diagram of a capacitive touch system according to another embodiment of the present disclosure.

FIG. 4 is a schematic diagram of an analog front end of a capacitive touch system according to one embodiment of the present disclosure.

FIG. 5 is schematic diagram of a frequency selection method of a capacitive touch system according to one embodiment of the present disclosure.

FIG. 6 is a flow chart of a frequency selection method of a capacitive touch system according to one embodiment of the present disclosure.

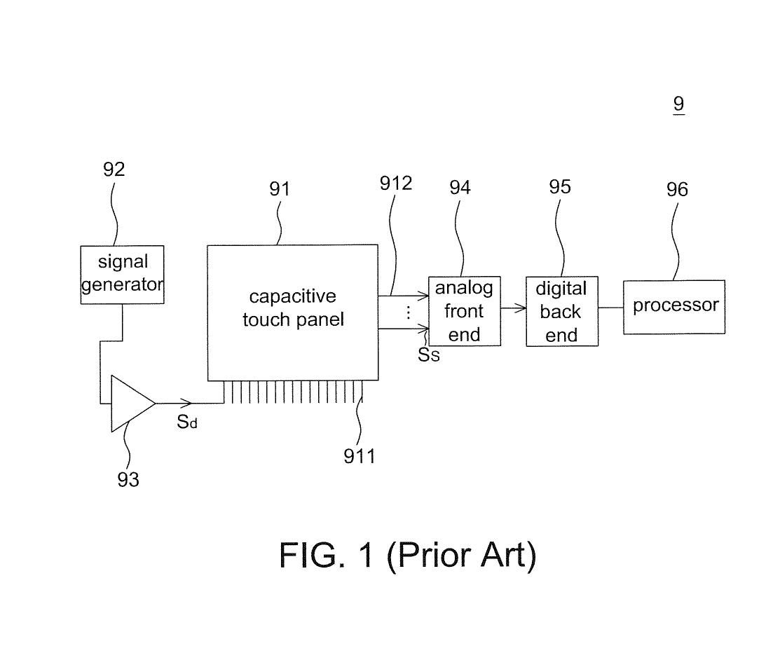

### DETAILED DESCRIPTION OF THE EMBODIMENT

It should be noted that, wherever possible, the same reference numbers will be used throughout the drawings to refer to the same or like parts.

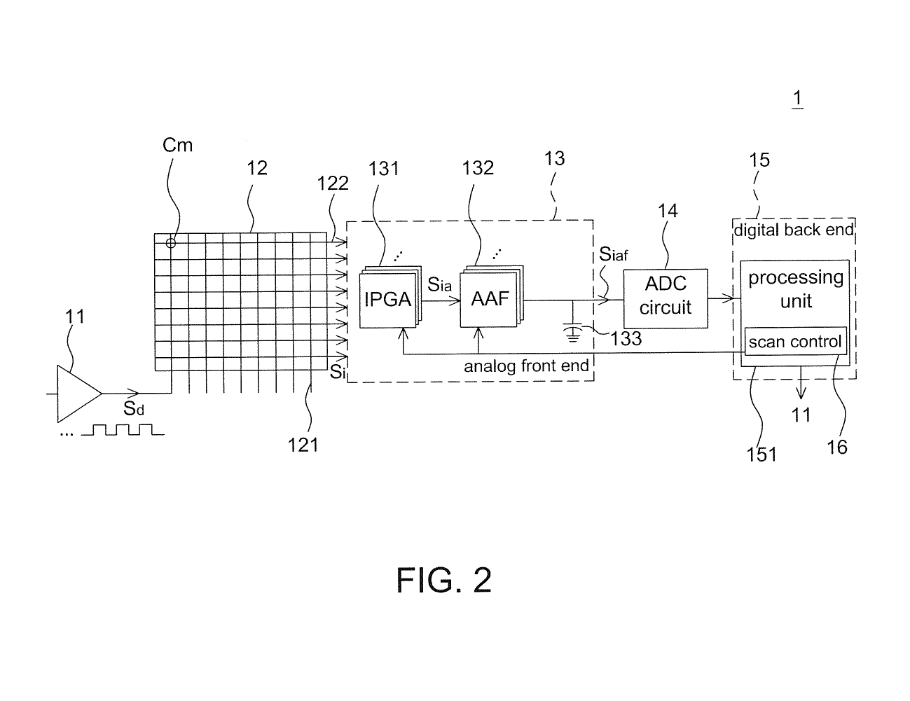

Referring to FIG. 2, it is a schematic block diagram of the capacitive touch system according to one embodiment of the present disclosure. The capacitive touch system 1 includes a plurality of driving units 11, a touch panel 12, an analog front end 13, an analog-to-digital conversion (ADC) circuit 14 and a digital back end 15. In some embodiments, the ADC circuit 14 may be included in the analog front end 13.

The analog front end 13 is configured to pre-process the analog signal outputted from the touch panel 12. Then, the pre-processed analog signal is converted to the digital signal by the ADC circuit 14 for the post-processing of the digital back end 15. Said pre-processing includes, for example, the amplification, downconversion, accumulation and filtering of the analog signal, but not limited thereto. Said post-processing includes, for example, identifying a touch position and/or a touch position variation (i.e. displacement) with respect to the touch panel 12 according to the digital signal, and identifying the noise level of the digital signal, but not limited thereto.

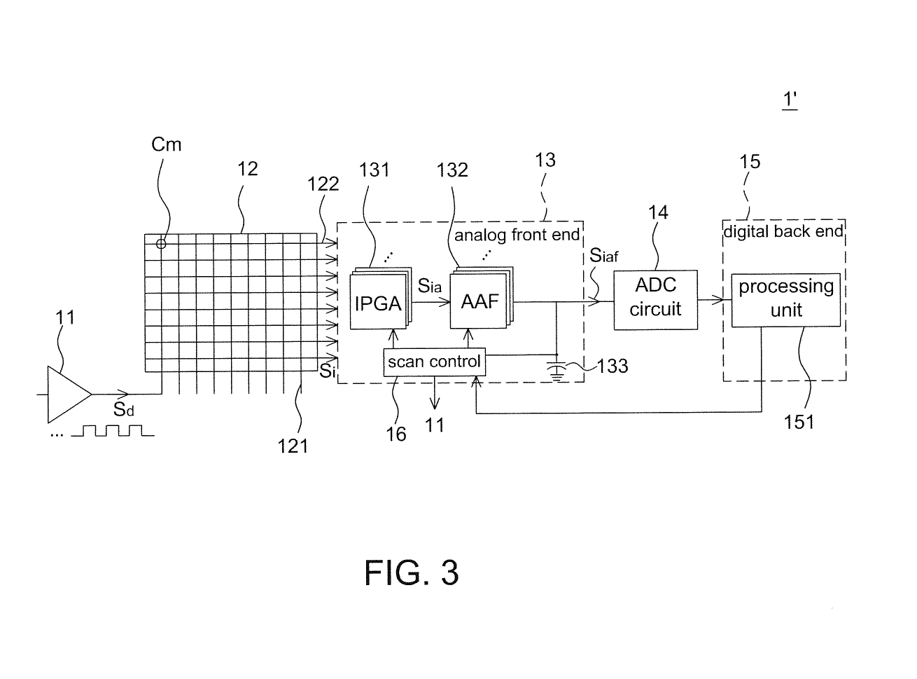

The touch panel 12 is, for example, a capacitive touch panel which includes a plurality of driving electrodes 121 and a plurality of sensing electrodes 122 configured to form inductive capacitance therebetween, wherein the inductive capacitance may be a self-capacitance and a mutual capacitance without particular limitations. For example, one driving electrode 121 may intersect with one sensing electrode 122 so as to form a sensing unit Cm, wherein FIGS. 2 to 3 only show one sensing unit Cm but for simplifying the drawings other sensing units Cm formed by other pairs of the driving electrodes 121 and the sensing electrodes 122 are not shown. The method of forming a plurality of driving electrodes and a plurality of sensing electrodes on a touch panel is well known and thus details thereof are not described herein.

When a driving signal Sd is inputted to the driving electrode 121, at least one detecting signal Si is induced on the sensing electrode 122 due to the inductive capacitance. When at least one finger or a conductor approaches the touch panel 12, the capacitance of the sensing units Cm nearby is changed to accordingly change the detecting signal Sl. Accordingly, the processing unit 15 may detect at least one touch position according to the capacitance variation. The method of a capacitive touch system inducing at least one detecting signal Si corresponding to a driving signal Sd through the inductive capacitance is well known and thus details thereof are not described herein. The present disclosure is to provide a capacitive touch system and a frequency selection method thereof capable of shortening a frequency scanning interval and reducing the power consumption of the frequency scanning interval.

The driving units 11 are respectively coupled to the driving electrodes 121 and configured to output a driving signal Sd at one of a plurality of predetermined driving frequencies to the driving electrode 121 coupled thereto within a driving interval, and not to output the driving signal Sd to the driving electrode 121 coupled thereto within a frequency scanning interval. Referring to FIG. 5, it is a schematic diagram of a frequency selection method of a capacitive touch system according to one embodiment of the present disclosure. The capacitive touch system 1 is arranged with, for example, a plurality of predetermined driving frequencies such as 75 KHZ, 100 KHZ, 200 KHZ, 300 KHZ, 400 KHZ and 500 KHZ, but not limited thereto. The driving unit 11 output a driving signal Sd having, for example, periodic driving waveforms or non-periodic driving waveforms to the driving electrode 121 coupled thereto, wherein said driving waveforms are, for example, square waves, sinusoidal waves, triangular waves or trapezoid waves and so on without particular limitations.

Preferably, each of the driving electrodes 121 is coupled to one driving unit 11. For simplification, FIGS. 2 and 3 only show one driving unit 11, but it is not to limit the present disclosure. In some embodiments, the driving units 11 may be coupled to the driving electrodes 121 respectively through a change-over switch (not shown) so as to control the connection or breakup between the driving units 11 and the driving electrodes 121. Each of the driving units 11 also can be coupled to more than one driving electrodes 121, that is to say more than one driving electrodes 121 can be driven with one driving signal Sd at the same time.

When the driving signal Sd is inputted to the driving electrode 121, the associated sensing electrode 122 then outputs at least one detecting signal Si to the analog front end 13. In this embodiment, the analog front end 13 includes a plurality of amplification units 131 configured to perform the signal amplification and a plurality of filters 132 configured to perform the signal filtering. In one embodiment, the sensing electrodes 122 are coupled to the amplification units 131 respectively through a change-over switch (not shown) so as to control the output of the detecting signal Si through the change-over switches.

The amplification units 131 are, for example, integrated programmable gain amplifier (IPGA) and respectively coupled to the sensing electrodes 122. In one embodiment, each of the amplification units 131 is coupled to one of the sensing electrodes 122 and configured to amplify the detecting signal Si outputted from the sensing electrode 122 coupled thereto and output an amplified detecting signal Sia. In this embodiment, the amplification units 131 have the characteristic of the high-pass filter and have a high-pass cutoff frequency.

The filters 132 are, for example, anti-aliasing filters and respectively coupled to the amplification units 131. In one embodiment, each of the filters 132 is coupled to one of the amplification units 131 and configured to filter the amplified detecting signal Sia and output an amplified and filtered detecting signal Siaf. In this embodiment, the filters 132 have the characteristic of the low-pass filter and have a low-pass cutoff frequency.

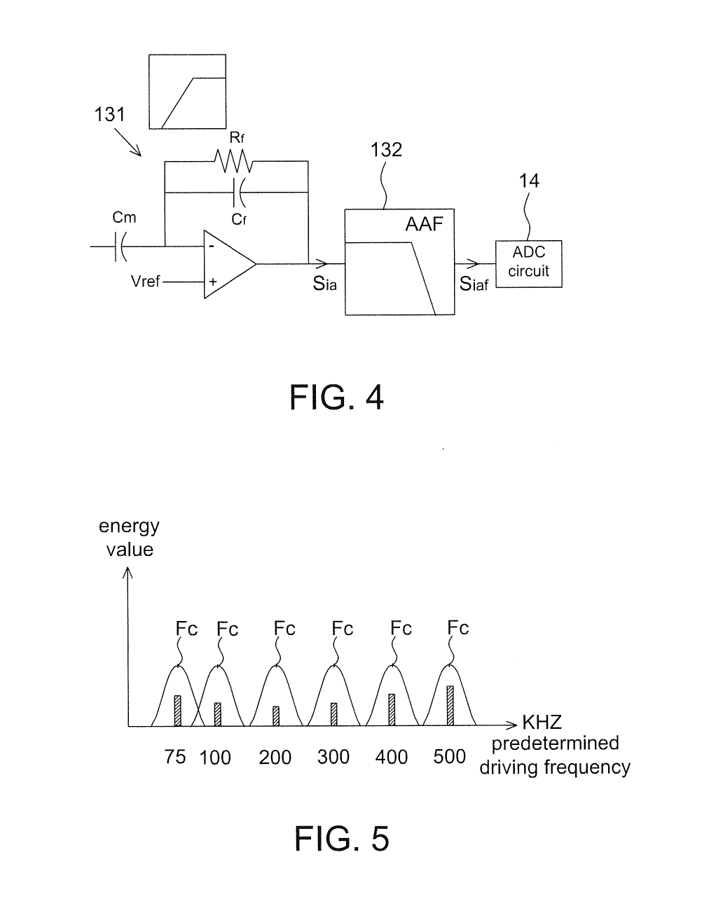

For example referring to FIG. 4, it is a schematic diagram of the amplification unit 131 and the filter 132 of the capacitive touch system 1 according to one embodiment of the present disclosure. The filter 132 outputs the amplified and filtered detecting signal Siaf to the ADC circuit 14 to be converted to the digital signal.

Referring to FIG. 2 again, the digital back end 15 includes a processing unit 151, which may be a digital signal processor (DSP), configured to perform the touch identification and determine whether to enter a frequency scanning mode, wherein the processing unit 15 may identify whether a conductor approaches the touch panel 12 according to the digital signal (e.g. obtained by digitizing the amplified and filtered detecting signal Siaf) detected within a predetermined detection interval (for example, but not limited to, 32 cycles of driving waveforms), and identify the signal-to-noise ratio (SNR) of the digital signal. For example in one embodiment, the driving unit 11 outputs the driving signal Sd at a current driving frequency to the touch panel 12, and the analog front end 13 further includes, for example, an accumulation capacitor 133 configured to accumulate charges of the amplified and filtered detecting signal Siaf within the predetermined detection interval. The ADC circuit 14 samples the voltage of the accumulation capacitor 133 and converts sampled values to the digital signal to be inputted to the processing unit 151. When the processing unit 151 identifies that an SNR value of the obtained digital signal is smaller than a threshold, the frequency scanning interval is entered, wherein the threshold may be determined according to the durable noise of the system without particular limitations.

In this embodiment, the processing unit 151 may further include a scan control unit 16 configured to control, in the frequency scanning interval, the high-pass cutoff frequency and the low-pass cutoff frequency so as to form an equivalent bandpass filter, and to adjust a center frequency of the equivalent bandpass filter to correspond to the predetermined driving frequencies. In addition, the scan control unit 16 is further configured to control, in the frequency scanning interval, the driving unit 11 to stop outputting the driving signal Sd to the touch panel 12 as well.

In one embodiment, the scan control unit 16 sequentially adjusts, in the frequency scanning interval, a center frequency Fc of the equivalent bandpass filter to be equal to each of the predetermined driving frequencies. For example in FIG. 5, the center frequency Fc of the equivalent bandpass filter is sequentially adjusted to substantially be equal to 75 KHZ, 100 KHZ, 200 KHZ, 300 KHZ, 400 KHZ and 500 KHZ, or vice versa. When the center frequency Fc is adjusted to each predetermined driving frequency, the scan control unit 16 detects the amplified and filtered detecting signal Siaf within a scan detection period (e.g. identical to or different from the predetermined detection interval of the driving interval, e.g. 32 cycles of driving waveforms). In the descriptions of the present disclosure, the frequency scanning interval is referred to an interval in which the touch panel 12 does not receive any driving signal Sd and the scan control unit 16 adjusts the cutoff frequencies, and the driving interval is referred to an interval in which the driving unit 11 inputs the driving signal Sd to the touch panel 12 and the processing unit 15 identifies the touch event according to the detected results.

In some embodiments, the scan control unit 16 identifies an amplified and filtered detecting signal having a smallest energy value among the amplified and filtered detecting signals Siaf associated with all the predetermined driving frequencies to accordingly determine a selected driving frequency. For example, the rectangular areas filled with slant lines in FIG. 5 indicate the detected energy values corresponding to each of the predetermined driving frequencies in the frequency scanning interval, and 200 KHZ is shown as the selected driving frequency herein. In some embodiments, said energy value may be an energy sum of the amplified and filtered detecting signals associated with at least a part of the sensing electrodes 122 outputted in the frequency scanning interval, e.g. adding amplified and filtered detecting signals Siaf associated with all the sensing electrodes 122 to be served as the energy value.

In another embodiment, after entering the frequency scanning interval, the scan control unit 16 may sequentially adjust the center frequency Fc of the equivalent bandpass filter to substantially be equal to rest predetermined driving frequencies among the predetermined driving frequencies other than the current driving frequency and two adjacent driving frequencies of the current driving frequency. As the frequency scanning interval is generally entered due to the high noise level in driving at the current driving frequency, the current driving frequency and its adjacent driving frequencies may be directly ignored in frequency scanning, e.g. two immediately adjacent driving frequencies thereof, but not limited thereto. In some embodiments, when the number of the predetermined driving frequencies is larger, a plurality of predetermined driving frequencies close to the current driving frequency may be ignored in the frequency scanning interval. Next, the scan control unit 16 may identify an amplified and filtered detecting signal having a smallest energy value among the amplified and filtered detecting signals Siaf associated with the rest predetermined driving frequencies so as to accordingly determine a selected driving frequency.

Referring to FIG. 3, it is a schematic block diagram of a capacitive touch system according to another embodiment of the present disclosure. The capacitive touch system 1′ also includes a plurality of driving units 11, a touch panel 12, an analog front end 13, an ADC circuit 14 and a digital back end 15. Similarly, the ADC circuit 14 may be included in the analog front end 13. The difference between this embodiment and FIG. 2 is that in this embodiment the scan control unit 16 is disposed in the analog front end 13 and configured to perform the frequency selection directly according to the energy value of the amplified and filtered detecting signal Siaf associated with the predetermined driving frequencies.

In one embodiment, the analog front end 13, for example, further includes an accumulation capacitor 133 configured to accumulate the amplified and filtered detecting signal Siaf within a predetermined detection interval. When the driving unit 11 outputs the driving signal Sd at a current driving frequency and the processing unit 151 identifies an SNR value of the obtained amplified and filtered detecting signal Siaf (e.g. obtained by sampling the accumulation capacitor 133 with the ADC circuit 14) is smaller than a threshold, a frequency scanning interval is entered. In the frequency scanning interval, the scan control unit 16 determines a selected driving frequency directly according to an amplified and filtered detecting signal having a smallest energy value among the amplified and filtered detecting signals Siaf associated with all the predetermined driving frequencies or the rest predetermined driving frequencies. It is appreciated that the method that the ADC circuit 14 samples the amplified and filtered detecting signal Siaf is not limited to sample the voltage of a capacitor as disclosed in the present disclosure.

In the above embodiments, as in the frequency scanning interval the driving unit 11 does not input any driving signal Sd to the touch panel 12, the amplified and filtered detecting signal Siaf outputted by the filters 132 only contain background noise, and thus the amplified and filtered detecting signal Siaf in the frequency scanning interval is sometimes referred to the amplified and filtered background signal for distinguishing.

In other words, according to FIGS. 2 and 3, the scan control unit 16 may be disposed in the analog front end 13 or in the digital back end 15 without particular limitations. The scan control unit 16 may identify a smallest energy sum according to the amplified and filtered detecting signal before being digitized (i.e. analog signal) or according to the amplified and filtered detecting signal after being digitized (i.e. digital signal) so as to accordingly determine a selected driving frequency.

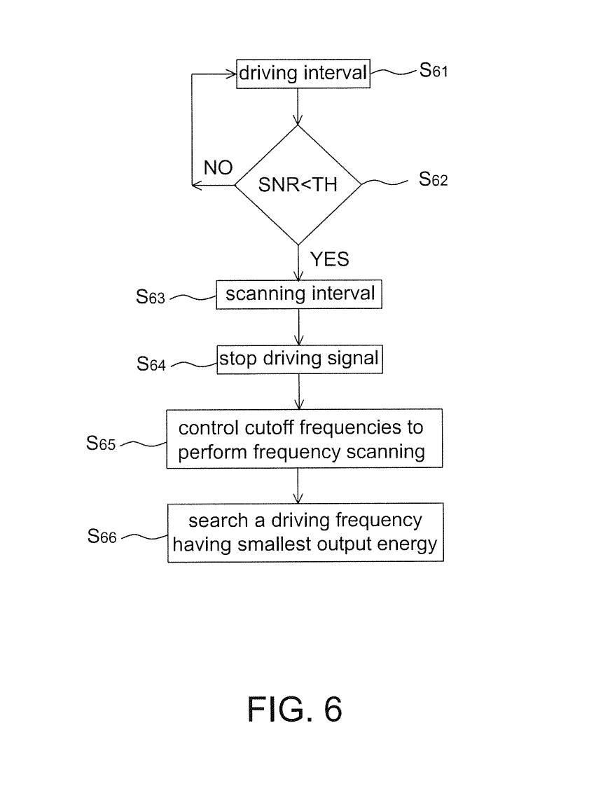

Referring to FIG. 6, it is a flow chart of a frequency selection method of a capacitive touch system according to one embodiment of the present disclosure, which includes the steps of: entering a driving interval (Step S₆₁); comparing an SNR value with a threshold (Step S₆₂); entering a frequency scanning interval when the SNR value is smaller than the threshold (Step S₆₃); deactivating driving signals (Step S₆₄); controlling cutoff frequencies to perform a frequency scanning (Step S₆₅); and searching a driving frequency having a lowest output energy value (Step S₆₆). The frequency selection method of this embodiment is adaptable to both the capacitive touch systems of FIGS. 2 and 3.

Referring to FIGS. 2 to 6, details of the frequency selection method of this embodiment are described hereinafter.

Step S₆₁: In a driving interval the driving unit 11 drives the touch panel 12 at a current driving frequency, and the driving signal Sd is induced as at least one detecting signal Si through the sensing unit Cm between the driving electrode 121 and the sensing electrode 122. The detecting signal Si sequentially passes through the amplification units 131 and the filters 132 to allow the filters 132 to respectively output an amplified and filtered detecting signal Siaf. The amplified and filtered detecting signal Siaf is, for example, accumulated in an accumulation capacitor 133 for a predetermined detection interval (e.g. 32 cycles of driving waveforms, but not limited thereto) and then converted to the digital signal by the ADC circuit 14. For simplification, the amplified and filtered detecting signal after being digitized is also referred as the amplified and filtered detecting signal herein.

Step S₆₂: The processing unit 151 identifies a touch event according to the amplified and filtered detecting signal Siaf and a noise level of the amplified and filtered detecting signal Siaf. When an SNR value of the amplified and filtered detecting signal Siaf exceeds a threshold, the driving interval (or touch detection mode) is maintained and the Step S₆₁ is returned; whereas when the SNR value is smaller than the threshold, a frequency scanning interval (or frequency scanning mode) is entered and the Step S₆₃ is entered.

Steps S₆₃˜S₆₄: In the frequency scanning interval, the scan control unit 16 controls the driving unit 11 to stop driving the touch panel 12 or control the change-over switches between the driving units 11 and the driving electrodes 121 to break off. Accordingly, the touch panel 12 only outputs the background signal to the amplification units 131 such that the filters 132 output amplified and filtered background signals.

Step S₆₅: After the driving signal Sd is ceased, the scan control unit 16 controls a high-pass cutoff frequency of the amplification units 131 and a low-pass cutoff frequency of the filters 132 to form an equivalent bandpass filter, and adjusts a center frequency Fc of the equivalent bandpass filter to correspond to a plurality of predetermined driving frequencies so as to determine a selected driving frequency according to the amplified and filtered background signal obtained by adjusting the center frequency Fc of the equivalent bandpass filter, as shown in FIG. 5. In one embodiment, a band of the equivalent bandpass filter may be 50-100 KHZ, but not limited thereto.

Step S₆₆: In one embodiment, the scan control unit 16 reads the amplified and filtered background signal, which is an analog signal or a digital signal according to the disposed position of the scan control unit 16, outputted from the filters 132. For example in FIG. 2, the scan control unit 16 is in the digital back end 15 and thus the amplified and filtered background signal is the digital background signal converted by the ADC circuit 14. For example in FIG. 3, the scan control unit 16 is in the analog front end 13 and thus the amplified and filtered background signal is the analog background signal not being converted by the ADC circuit 14. In one embodiment, the scan control unit 16 identifies an amplified and filtered background signal having a smallest energy value among the amplified and filtered background signals associated with all the predetermined driving frequencies so as to accordingly determine a selected driving frequency. In another embodiment, the scan control unit 16 identifies an amplified and filtered background signal having a smallest energy value among the amplified and filtered background signals associated with the rest predetermined driving frequencies (i.e. other than the current driving frequency and its adjacent predetermined driving frequencies) so as to accordingly determine a selected driving frequency.

In one embodiment, the analog front end 13 and the digital back end 15 may form a readout circuit configured to couple to a touch panel 12 and read a plurality of detecting signals Si outputted by the touch panel 12. The readout circuit includes a plurality of amplification units 131, a plurality of filters 132 and a scan control unit 16. The amplification units 131 are coupled to the touch panel 12 and configured to amplify the detecting signals Si outputted by the touch panel 12, and have a high-pass cutoff frequency. The filters 132 are respectively coupled to the amplification units 131 and configured to output an amplified and filtered detecting signal Siaf, and have a low-pass cutoff frequency. The scan control unit 16 is configured to control the high-pass cutoff frequency of the amplification units 131 and the low-pass cutoff frequency of the filters 132 to form an equivalent bandpass filter, and adjust a center frequency Fc of the equivalent bandpass filter to correspond to at least a part of a plurality of predetermined driving frequencies of the touch panel 12, as shown in FIG. 5. As mentioned above, the scan control unit 16 may determine a selected driving frequency according to one amplified and filtered detecting signal having a smallest energy value among the amplified and filtered detecting signals Siaf associated with all or at least a part of the predetermined driving frequencies.

As mentioned above, in the conventional capacitive touch system, a suitable driving frequency is selected by inputting the driving signals of different driving frequencies to a touch panel and identifying the SNR value of the detecting signals outputted by the touch panel. However, the frequency hopping process of the conventional capacitive touch panel needs to spend more time and power in order to confirm the suitable driving frequency. Therefore, the present disclosure further provides a capacitive touch system (FIGS. 2 to 3) and a frequency selection method thereof (FIG. 6) in which a high-pass cutoff frequency of the amplification units and a low-pass cutoff frequency of the filters are adjusted so as to determine a selected driving frequency according to the amplified and filtered background signal associated with the predetermined driving frequencies having a smallest energy value. As in the frequency scanning interval of the present disclosure there is no driving signal inputted to the touch panel, it is able to shorten a frequency scanning interval and reduce the power consumption of the scanning interval.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

What is claimed is:

1. A capacitive touch system comprising:
a touch panel comprising a plurality of driving electrodes and a plurality of sensing electrodes configured to form inductive capacitance;
a driving unit, coupled to one of the driving electrodes, configured to output a driving signal at one of a plurality of predetermined driving frequencies in a driving interval and not output the driving signal to the driving electrode coupled thereto in a frequency scanning interval;
a plurality of amplification units, respectively coupled to the sensing electrodes, configured to amplify a detecting signal outputted by the sensing electrode coupled thereto, and having a high-pass cutoff frequency;
a plurality of filters, respectively coupled to the amplification units, configured to output an amplified and filtered detecting signal, and having a low-pass cutoff frequency; and
a scan control unit configured to
control the high-pass cutoff frequency and the low-pass cutoff frequency in the frequency scanning interval to form an equivalent bandpass filter, and
adjust a center frequency of the equivalent bandpass filter to correspond to the predetermined driving frequencies.

2. The capacitive touch system as claimed in claim 1, wherein in the frequency scanning interval the scan control unit is configured to adjust the center frequency of the equivalent bandpass filter to sequentially equal to each of the predetermined driving frequencies.

3. The capacitive touch system as claimed in claim 2, wherein the scan control unit is further configured to determine a selected driving frequency according to an amplified and filtered detecting signal having a smallest energy value among the amplified and filtered detecting signals associated with all the predetermined driving frequencies.

4. The capacitive touch system as claimed in claim 3, wherein the energy value is an energy sum of the amplified and filtered detecting signals outputted from at least a part of the filters in the frequency scanning interval.

5. The capacitive touch system as claimed in claim 1, wherein when an SNR value of the amplified and filtered detecting signal obtained in the driving interval when the driving unit outputs the driving signal at a current driving frequency is smaller than a threshold, the frequency scanning interval is entered.

6. The capacitive touch system as claimed in claim 5, wherein in the frequency scanning interval the scan control unit is configured to
adjust the center frequency of the equivalent bandpass filter to sequentially be equal to rest predetermined driving frequencies other than the current driving frequency and adjacent driving frequencies of the current driving frequency among the predetermined driving frequencies, and
determine a selected driving frequency according to an amplified and filtered detecting signal having a smallest energy value among the amplified and filtered detecting signals associated with the rest predetermined driving frequencies.

7. The capacitive touch system as claimed in claim 1, wherein the scan control unit is in an analog front end or a digital back end.

8. A frequency selection method of a capacitive touch system, the capacitive touch system comprising a touch panel, a plurality of amplification units respectively coupled to a plurality of sensing electrodes of the touch panel, and a plurality of filters respectively coupled to the amplification units, the frequency selection method comprising:
driving the touch panel with a driving signal at a current driving frequency to allow the filters to respectively output an amplified and filtered detecting signal;
entering a frequency scanning interval when an SNR value of the amplified and filtered detecting signal is smaller than a threshold;
stopping driving the touch panel in the frequency scanning interval;
controlling a high-pass cutoff filter of the amplification filters and a low-pass cutoff frequency of the filters to form an equivalent bandpass filter; and
adjusting a center frequency of the equivalent bandpass filter to correspond to a plurality of predetermined driving frequencies.

9. The frequency selection method as claimed in claim 8, wherein in the frequency scanning interval the center frequency of the equivalent bandpass filter is sequentially adjusted to be equal to each of the predetermined driving frequencies.

10. The frequency selection method as claimed in claim 9, further comprising:
reading amplified and filtered background signals outputted by the filters; and
selecting an amplified and filtered background signal having a smallest energy value among the amplified and filtered background signals associated with all the predetermined driving frequencies.

11. The frequency selection method as claimed in claim 10, wherein the energy value is an energy sum of the amplified and filtered background signals outputted by at least a part of the filters in the frequency scanning interval.

12. The frequency selection method as claimed in claim 8, wherein in the frequency scanning interval the center frequency of the equivalent bandpass filter is sequentially adjust to be equal to rest predetermined driving frequencies other than the current driving frequency and adjacent driving frequencies of the current driving frequency among the predetermined driving frequencies.

13. The frequency selection method as claimed in claim 12, further comprising:
reading amplified and filtered background signals outputted by the filters; and
selecting an amplified and filtered background signal having a smallest energy value among the amplified and filtered background signals associated with the rest predetermined driving frequencies.

14. A frequency selection method of a capacitive touch system, the capacitive touch system comprising a driving unit, a touch panel, a plurality of amplification units respectively coupled to a plurality of sensing electrodes of the touch panel, and a plurality of filters respectively coupled to the amplification units, the frequency selection method comprising:
a frequency scanning interval, in which the driving unit does not output any driving signal to the touch panel, the amplification units and the filters are configured to form an equivalent bandpass filter to output an amplified and filtered background signal, and a selected driving frequency is determined according to the amplified and filtered background signal obtained by adjusting a center frequency of the equivalent bandpass filter.

15. The frequency selection method as claimed in claim 14, where in the frequency scanning interval the center frequency of the equivalent bandpass filter is sequentially adjusted to be equal to each of the predetermined driving frequencies.

16. The frequency selection method as claimed in claim 15, wherein the selected driving frequency is determined according to an amplified and filtered background signal having a smallest energy value among the amplified and filtered background signals associated with all the predetermined driving frequencies.

17. The frequency selection method as claimed in claim 14, further comprising a driving interval in which the driving unit outputs a driving signal at a current driving frequency to the touch panel to allow the filters to respectively output an amplified and filtered detecting signal, wherein when an SNR value of the amplified and filtered detecting signal is smaller than a threshold, the frequency scanning interval is entered.

18. The frequency selection method as claimed in claim 17, wherein in the frequency scanning interval the center frequency of the equivalent bandpass filter is sequentially adjust to be equal to rest predetermined driving frequencies other than the current driving frequency and adjacent driving frequencies of the current driving frequency among a plurality of predetermined driving frequencies.

19. The frequency selection method as claimed in claim 18, wherein the selected driving frequency is determined according to an amplified and filtered background signal having a smallest energy value among the amplified and filtered background signals associated with the rest predetermined driving frequencies.

20. The frequency selection method as claimed in claim 14, wherein the amplified and filtered background signal is an analog signal or a digital signal.

21. A readout circuit, configured to couple to a touch panel and read a plurality of detecting signals outputted by the touch panel, the readout circuit comprising:
a plurality of amplification units, coupled to the touch panel, configured to amplify the detecting signals outputted by the touch panel and having a high-pass cutoff frequency;
a plurality of filters, respectively coupled to the amplification units, configured to output an amplified and filtered detecting signal and having a low-pass cutoff frequency; and
a scan control unit configured to
control the high-pass cutoff frequency and the low-pass cutoff frequency to form an equivalent bandpass filter, and
adjust a center frequency of the equivalent bandpass filter to correspond to at least a part of a plurality of predetermined driving frequencies of the touch panel.

22. The readout circuit as claimed in claim 21, wherein the scan control unit is configured to adjust the center frequency of the equivalent bandpass filter to sequentially equal to each of the predetermined driving frequencies.

23. The readout circuit as claimed in claim 22, wherein the scan control unit is further configured to determine a selected driving frequency according to an amplified and filtered detecting signal having a smallest energy value among the amplified and filtered detecting signals associated with all the predetermined driving frequencies.

24. The readout circuit as claimed in claim 23, wherein the energy value is an energy sum of the amplified and filtered detecting signals outputted from at least a part of the filters.

25. The readout circuit as claimed in claim 21, wherein the scan control unit is further configured to determine a selected driving frequency according to an amplified and filtered detecting signal having a smallest energy value among the amplified and filtered detecting signals associated with the at least a part of the predetermined driving frequencies.

26. The readout circuit as claimed in claim 25, wherein the energy value is an energy sum of the amplified and filtered detecting signals outputted from at least a part of the filters.
